(19) United States
(12) Patent Application Publication
(10) Pub. No.: US 2004/0057606 A1
(43) Pub. Date: Mar. 25, 2004

(54) Apparatus for capturing a palmprint image

(75) Inventors: Zhang Dapeng David, Hung Hom (HK); Niu Xuan, Hung Hom (HK); Lu Guang Ming, Hung Hom (HK); Kong Wai-Kin Adams, Hung Hom (HK); Wong Keung Ming, Hung Hom (HK)

Correspondence Address: Jackson Walker LLP, 112 E Pecan Street Suite 2100, San Antonio, TX, 78205, US

(73) Assignee: The Hong Kong Polytechnic University, Hung Hom (HK)

(21) Appl. No.: 10/253,912

(22) Filed: Sep. 25, 2002

(51) Int. Cl. G06K 9/00

(52) U.S. Cl. 382/126

(57) ABSTRACT

A palmprint image capture apparatus includes an enclosure with a window in it, and an image sensor and light source disposed within the enclosure and arranged to capture an image through the window. Protuberances are provided on the surface. The protuberances are arranged to be in known juxtaposition to a hand suitably placed on the window for capture of an image that includes the palm area of the hand.

### BACKGROUND TO THE INVENTION

1. Field of the Invention

The invention relates to biometrics identification and in particular to an apparatus for capturing a palmprint image for the identification of an individual.

2. Background Information

Using palmprint recognition as a method for personal identification is a new biometrics technology. Known methods include analyzing a palmprint to identify singular points, minutiae, and wrinkles in a palmprint image. These known methods require a high-resolution image that can be obtained by way of scanning and inked palmprint image. However, this is a messy process and it cannot be used passively for real-time identification.

To overcome the problem of inked palmprints some companies have developed high-resolution palmprint scanners and identification systems. However, these devices capturing high-resolution images are costly and rely on high performance computers to fulfil the requirements of real-time identification.

### SUMMARY OF THE INVENTION

It is an object of the present invention to provide an apparatus for capturing a palmprint image, which overcomes or ameliorates the above disadvantages or at least which provides the public with a useful alternative.

According to the invention there is provided a palmprint image capture apparatus including:

an enclosure having a window in it,

an image sensor disposed within the enclosure and arranged to capture an image through the window,

a light source disposed to illuminate the window, and

at least one protuberances adjacent the window, wherein the protuberance(s) is/are arranged to be in known juxtaposition to a hand suitably placed on the window for capture of an image that includes the palm of the hand.

Preferably, the protuberances are pegs or pins disposed to be between two or more fingers of the hand suitably placed on the window.

Preferably, the light source is an annulus with the image sensor at its center.

Preferably, the image sensor is a Charged-Coupled Device (CCD) or Complementary Metal Oxide Semiconductor (CMOS) sensor.

Further aspects of the invention will become apparent from the following description, which is given by way of example only,

### BRIEF DESCRIPTION OF THE DRAWINGS

Embodiments of the invention will now be described with reference to the accompanying drawings in which:

FIG. 1 illustrates a schematic of a palmprint image capture device according to invention,

FIG. 2 is a plan view of the image capture surface of the device,

FIG. 3 is a sectional view through A-A′ of FIG. 1, where a CCD camera is revolted by the circle light, and

FIG. 4 illustrates a raw palm image captured by the apparatus.

### DESCRIPTION OF THE PREFERRED EMBODIMENTS

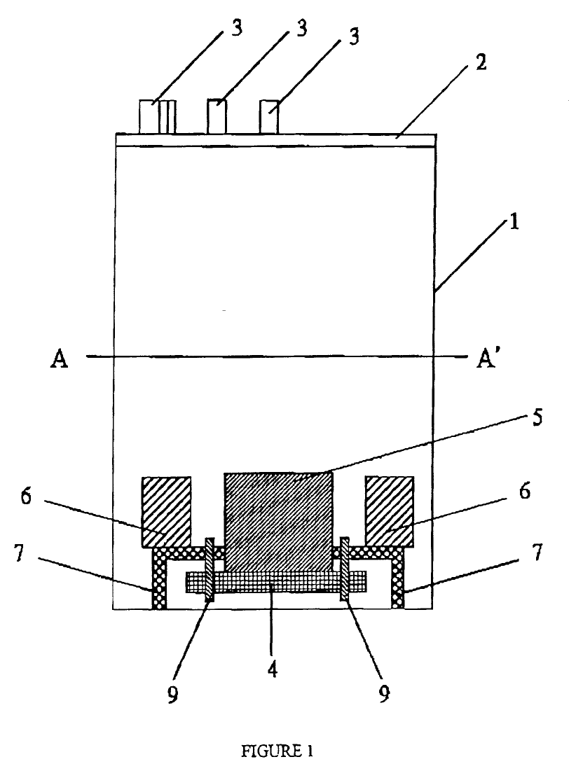

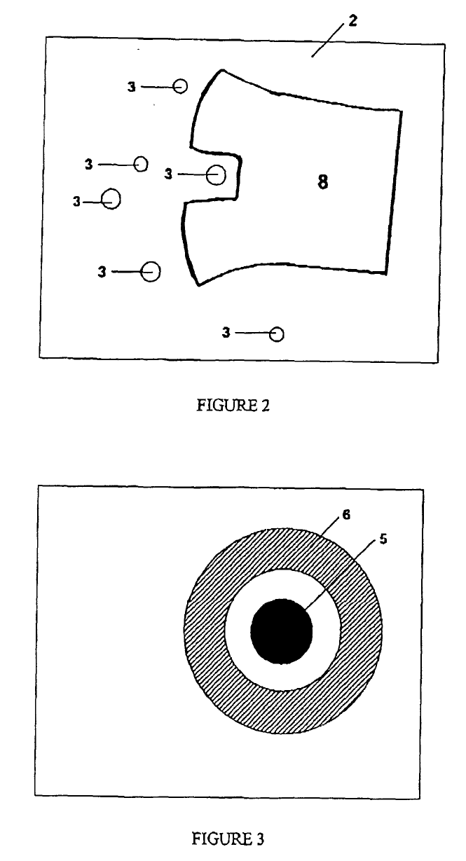

Referring to the drawings, FIGS. 1 and 2 illustrates a palmprint image capture apparatus according to the invention. The apparatus includes a housing 1 with a flat top surface 2 on which a hand is placed, palm down, for the capture of the palmprint image. The surface 2 is opaque with a window 8 through which the image is captured. In the preferred embodiment the window 8 contains a glass panel. In alternative embodiments the window 8 may contain other transparent coverings, a lens or nothing (i.e. an open window).

An image sensor such as a charge coupled device (CCD) 4 is mounted within housing 1. A lens 5 is screwed on the CCD. The aperture of the lens 5 is orientated towards window 8 in surface 2.

An annular light source 6 is mounted around the lens 5 to illuminate an image in window 8. Mounting arms 7 support the annular light source 6 and screws 9 are used to mount the CCD firmly on the mounting arms 7. A palmprint image can be formed through this optical plane from lens 5 to CCD 4, then the digitized imagery data are transferred to an external processor such as a personal computer (not shown) for processing and manipulating.

Referring to FIG. 3, a plan view of the lens 5 and light source 6 through section A-A′ of FIG. 1 is shown. The lens 5 is at the centre of the annular light source 6. The lens 5 is mounted on the top of the CCD 4.

Adjacent window 8 in surface 2 are a plurality of protuberances in the form of pegs 3 which are used to correctly position a hand on surface 2 with the palm area over the window 8. In use, a person places their hand on the surface 2 to locate pegs 3 between the fingers and thumb of the hand. This ensures that the hand is placed correctly on the apparatus for the capture of the optimal area of the palm through window B.

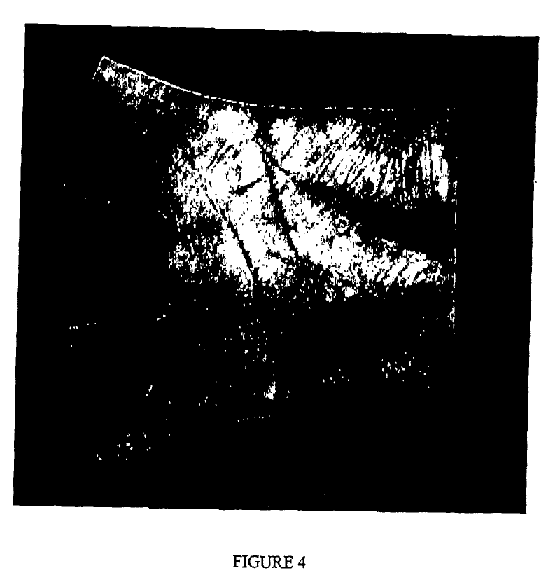

FIG. 4 shows an image of the target palm area captured through window 8. It is apparent that using an opaque surface 2 with a target window 8 ensures that the area of interest from the palm can be obtained accordingly. This image is acquired from CCD 4 by the personal computer for further processing.

A palmprint obtained by the apparatus is suitable for use in biometrics identification. The features and characteristics of the palmprint can be obtained and then compared to the database record to identify an individual. A number of techniques can be used to determine the characteristics of the palm in the image. One suitable technique is texture analysis. Texture analysis is suitable because it gives a high level of accuracy on low-resolution images.

The described embodiment uses a CCD image sensor. In an alternative embodiment a Complementary Metal Oxide Semiconductor (CMOS) sensor is used. The CMOS sensor yields lower resolution at a lower cost. However, this is ameliorated if texture analysis is used.

In the preferred embodiment the protuberances adjacent the window 8 are pegs 3. In an alternative embodiment the surface 2 with window 8 is made with a depression or concavity into which the hand can be placed palm down.

Where in the foregoing description reference has been made to integers or elements having known equivalents then such are included as if individually set forth herein.

Embodiments of the invention have been described, however it is understood that variations, improvements or modifications can take place without departure from the spirit of the invention or scope of the appended claims.

What is claimed is:

1. A palmprint image capture apparatus including:
an enclosure with a window in it,
an image sensor disposed within the enclosure and arranged to capture an image through the window,
a light source disposed to illuminate the window, and
at least one protuberance adjacent the window, wherein the protuberance(s) is/are arranged to be in known juxtaposition to a hand suitably placed on the window for capture of an image that includes the palm area of the hand.

2. A palmprint image capture apparatus as claimed in claim 1 wherein the protuberances are pegs or pins disposed to be between the two or more fingers of the hand suitably placed on the window.

3. A palmprint image capture apparatus as claimed in claim 1 wherein the light source is an annulus with the image sensor at its center.

4. A palmprint image capture apparatus as claimed in claim 1 wherein the image sensor is a Charged-Coupled Device (CCD) or Complementary Metal Oxide Semiconductor (CMOS) sensor.

5. A palmprint image capture apparatus including:
an enclosure having a window in it,
an image sensor disposed within the enclosure and arranged to capture an image through the window,
a light source disposed to illuminate the window,
a controller operable to control the image sensor and light source for capturing an image, and
at least one protuberance, wherein the protuberance(s) is/are arranged to be in known juxtaposition to a hand suitably placed on the window for capture of an image that includes the palm area of the hand.

6. A palmprint image capture apparatus as claimed in claim 5 wherein the protuberances are pegs or pins disposed to be between the two or more fingers of the hand suitably placed on the window.

7. A palmprint image capture apparatus as claimed in claim 5 wherein the light source is an annulus with the image sensor at its center.

8. A palmprint image capture apparatus as claimed in claim 5 wherein the image sensor is a Charged-Coupled Device (CCD) or Complementary Metal Oxide Semiconductor (CMOS) sensor.
